(19) United States
(12) Patent Application Publication
(10) Pub. No.: US 2009/0138139 A1
(43) Pub. Date: May 28, 2009

(54) TECHNICAL DATA NAVIGATION SYSTEM AND METHOD

(76) Inventors: Ta C. Tsai, Irvine, CA (US); Michael T. Clare, Tukwila, WA (US); Stephen H. Queen, Tukwila, WA (US)

Correspondence Address: Hayes Soloway P.C., 3450 E. Sunrise Drive, Suite 140, Tucson, AZ, 85718, US

(21) Appl. No.: 11/945,121

(22) Filed: Nov. 26, 2007

(51) Int. Cl. G01M 17/00; G06F 19/00; G06Q 30/00

(52) U.S. Cl. 701/3; 701/33; 705/26

(57) ABSTRACT

The present invention is directed to a technical data navigation system and method that provides a single point of access search, retrieve and aggregate vehicle post delivery technical data via a lightweight three-dimensional (3D) navigational interface. The system and method provide for a streamlined process of virtually locating and identifying parts on a vehicle. The system and method further provide for a single point for interaction of delivering 3D simulations.

### FIELD

The present disclosure pertains to vehicles, in general, and to a system and method for providing information for the repair and maintenance of such vehicles including aircraft, in particular.

### BACKGROUND

Aircraft mechanics go through a non-intuitive method for locating parts of an aircraft. When physically working on an aircraft, airline mechanics must manually locate and validate parts of interest. Relevant drawings and diagrams are provided in documents such as Service Bulletins, Maintenance Manuals, Structural Repair Manuals, Illustrated Parts Catalog, and the like. All drawings and diagrams in the maintenance and repair manuals are represented in a two-dimensional (2D) “flat” format. Typically complex 2D illustrations in these documents show hundreds if not thousands of complex joined parts. Translating a 2D illustration to a three-dimensional (3D) view of parts of interest may be confusing, cause delays and create unnecessary workload.

In addition, work instructions for these complex parts provided in the documents are often text-based. Text-based instructions require detail understandings, examinations, and validations which are not visually intuitive to interpret. Still further, work instructions contained in the documents are often referenced to other work instructions in other documents which created decentralized work procedures that make document aggregation tasks unproductive and time consuming.

### SUMMARY

A technical data navigation system for virtual searching, retrieving and aggregating technical information related to vehicular maintenance and repair is provided in accordance with the principles of the disclosure.

An illustrative embodiment in accordance with the disclosure comprises a technical data navigation system server. A technical data navigation system client is coupleable to the technical data navigation server via the world wide web. A user interface is provided to the client to access and display data obtained from the technical data navigation system server. The user interface comprises a three dimensional viewer providing three dimensional navigation of a vehicle and its component subsystems and parts. The system of the embodiment disclosed also comprises a parts geometry database, a virtual work instructions database, a data repository server accessible by the technical data navigation server to respond to queries from the user interface and to provide data retrievals to the user interface from the parts geometry database and the virtual work instructions database. The parts geometry database is generated by a parts and structures assembly and generation program and the virtual work instructions database comprises virtual work instructions generated by a virtual work instructions authoring program.

In the disclosed illustrative embodiment, the user interface provides a plurality of windows. One window provides a three dimensional view of an image of the vehicle upon which a user may select a portion for closer view in a second one of the windows. The portion is presented in a three dimensional view upon which the user may select a part for viewing in a third one of the plurality of windows; the selected part being displayed in a three dimensional view. The system server automatically provides to the user a three dimensional virtual work instructions simulation in one of the plurality of windows.

In the illustrative embodiment, the user interface also provides a hierarchal specification tree view of parts by at least one of a product structure, Air Transport Association (ATA) chapters which deal with the different aircraft assemblies and systems, and maintenance zone. In addition, the user interface displays a list of parts by at least one of part numbers and damage location. Still further, the user interface displays navigating shortcut thumbnails to major maintenance zones of the vehicle.

A technical data navigation method for searching, retrieving and aggregating links related to vehicular maintenance and repair is provided in accordance with the disclosure. One illustrative embodiment of the disclosure comprises the steps of: receiving user inputs for diagnosing symptoms of an aircraft; utilizing the symptoms to isolate the occurrence of a corresponding fault; providing a technical data navigation system comprising a user interface; utilizing the user interface on a technical data navigation system client to access and display data obtained from the technical data navigation system; utilizing the user interface to provide a three dimensional viewer providing three dimensional navigation of the vehicle and its component subsystems and parts; utilizing the user interface to provide a hierarchal specification tree view of parts; utilizing the user interface to provide a list of parts by at least one of part numbers and damage location; utilizing the user interface to provide navigating shortcut thumbnails to major maintenance zones of the vehicle; providing a parts geometry database; responding to selections via the user interface to search, retrieve, aggregate and display at the user interface documents relevant to a part of interest; providing a virtual work instructions database of three dimensional simulations; and utilizing the user interface to launch and display three dimensional virtual simulations of work instructions from the virtual work instructions database.

The features, functions, and advantages of the invention can be achieved independently in various embodiments of the present invention or may be combined in yet other embodiments further details of which can be seen with reference to the following description and drawing figures.

### BRIEF DESCRIPTION OF THE DRAWINGS

The invention will be better understood from a reading of the following detailed description of one embodiment in accordance with the principles of the invention in conjunction with the drawing figures in which, like reference designators identify like elements, and in which:

FIG. 1 illustrates one embodiment of a system in accordance with the principles of the invention;

FIG. 2 illustrates a representation of a user interface; and

FIGS. 3A and 3B illustrate the functional operation of the system of FIG. 1.

### DETAILED DESCRIPTION

The present disclosure is directed to a technical data navigation system and method that provides a single point of access to search, retrieve, and aggregate vehicle post delivery technical data via a lightweight three-dimensional (3D) navigational web interface. The system and method provide for a streamlined process of locating and identifying parts on a vehicle virtually. The system and method further provide for a single point for interaction of delivering 3D simulations via an Internet or world-wide web interface.

It will be appreciated by those skilled in the art that although the illustrative embodiment described herein is directed to a technical data system and method for aircraft, the principles of the disclosure are not limited to aircraft but are equally applicable to other vehicles including, but not limited to, watercraft including ships and boats, space craft, and land vehicles of all types including military vehicles of all types. As used herein, the term vehicle is intended to encompass all varieties of vehicles including land, water, air and space vehicles.

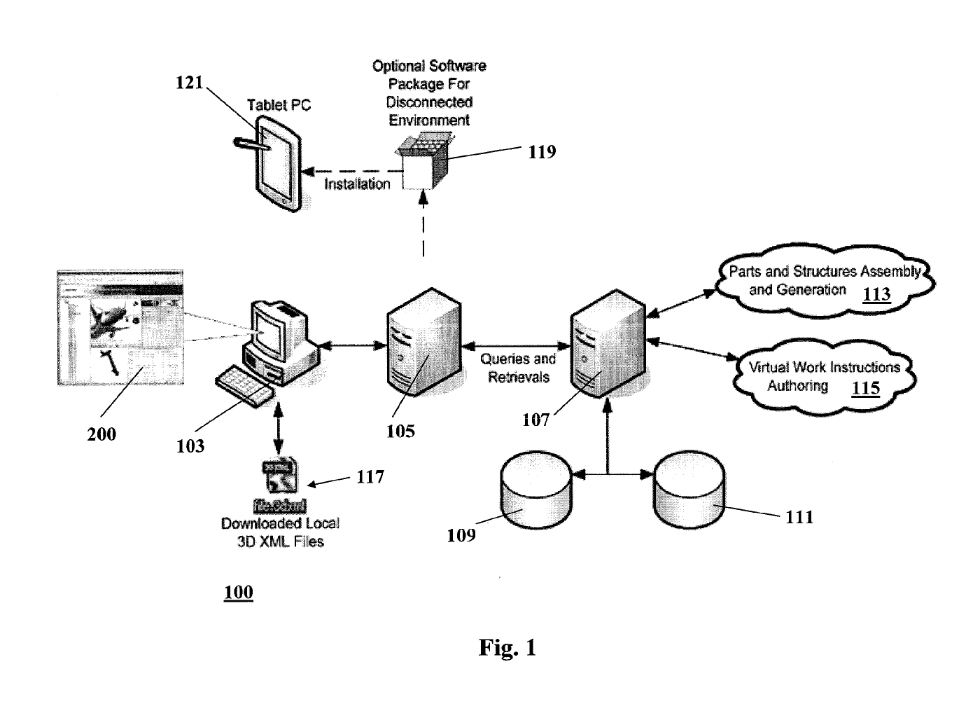

The illustrative embodiment of the technical data navigation TDN system 100 is shown in FIG. 1. TDN system 100 comprises a user interface 200 that is provided on a client 103. Client 103 is a computer which may be a personal computer, lap top computer, tablet computer or any other computer which an aircraft mechanic or other user has access to and which has access to the Internet or world wide web. Client 103 is loaded with and operates a three dimensional player in a Windows environment that permits client 103 to display three dimensional visualizations in multiple windows. The three dimensional player may be 3D XML which is a universal lightweight XML-based format that is commercially available. The three dimensional player provides 3D visualizations of an aircraft, subassemblies of the aircraft and specific parts of the subassemblies. In addition, the three dimensional viewer is utilized in conjunction with displaying virtual work instructions for replacement and/or removal of parts.

Client 103 communicates via the world-wide web with technical data navigation system TDN server 105. TDN server 105 hosts a web site which provides access to TDN data repository server 107. Both TDN server 105 and repository server 107 may be commercially available servers.

Repository server 107 includes 3D simulation files that are utilized to provide 3D virtual simulations to client 103 in response to queries forwarded from client 103. Repository server 107 has links to a geometry data warehouse 109. Data warehouse 109 comprises one or more databases that contain digital files for all post delivery documentation for various aircraft. The documentation includes drawings and diagrams and related information typically provided in documents such as Service Bulletins, Maintenance Manuals, Structural Repair Manuals, Illustrated Parts Catalog, and the like. In addition, repository server 107 has links to a virtual work instructions data warehouse 111. Repository server 107 includes one or more computer programs 113 that provide parts and structures assembly and generation to identify and aggregate responses to queries from client 103 utilizing data files stored in geometry data warehouse 109. In addition, repository server 107 includes one or more computer programs 115 that translate repair steps obtained from geometry data warehouse 109 and virtual work instructions warehouse 111 into 3D simulations of virtual repairs for display by user interface 200. Advantageously, an aircraft mechanic or other user, utilizing user interface 200, can view the simulated virtual repair, and replay it as necessary to provide visual guidance in the exact methodology that is recommended for the replacement of one or more parts or subassemblies of an aircraft. The simulations of virtual repairs can are stored in virtual instructions warehouse 111 to provide a library of such simulations.

Client 103 generates queries for information from TDN system 100 which, in turn, forwards the queries to repository server 107 via the world-wide web. Client 103 receives responses via TDN server 105. Client 103 includes downloaded 3D XML Player files 117 that facilitate the three-dimensional viewing of the aircraft of interest, subassemblies and parts and virtual simulations of repairs and parts replacement.

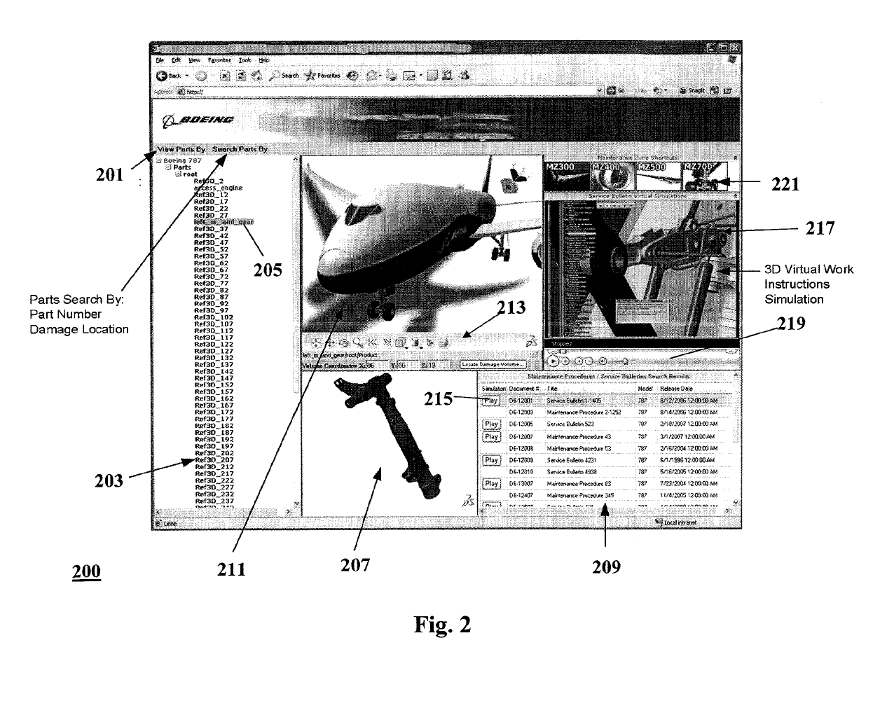

Client 103 is utilized to provide user interface 200 which is shown in detail in FIG. 2. User interface 200 provides the ability to view technical data from any related parts via a parts interface. User interface 200 is arranged to provide window frames that are utilized to navigate to the part of interest by a parts interface. The parts interface is multi-faceted and includes the ability to identify parts by means of viewing the aircraft in 3D, and navigating over the 3d view to product structures of interest and to “drill down” to the specific part of interest.

User interface 200 includes a parts navigation menu 201. By utilizing navigation menu 201, a user can view a parts specification listing by product structure, ATA chapters, or maintenance zone or by a damage zone on the aircraft. After a user selects one of the alternate listings, a parts specification list is provided in window 203. From the parts specification list in window 203, a user can click on a part, indicated by way of example as part 205, and the 3D navigational viewer will automatically navigate to that part rendered in the 3D viewer in window 211. Subsequently, a search process is launched by repository server 107 to identify relevant technical data associated with the identified part. The search inquiry would return post delivery documents such as Service Bulletins, Maintenance Manuals, and Structural Repair Manuals relative to the selected part and display the results in another window 209. Detailed parts information such as part number, unit price, supplier code, and inventory count are also displayed in window 209 for the selected part.

The user can navigate to a part on an aircraft via the 3D navigational viewer directly. The 3D viewer is provided in window 211. The 3D navigational viewer includes a tool bar 213 that can be utilized to help in the navigation. The user may change the view of the aircraft and drill down to the area of interest on the aircraft. When the user identifies the particular area of interest, the user can click on that area and an enlarged view of that particular area appears in window 207. Once the part of interest is found and selected in the 3D viewer of window 211, the location of the part in the parts specification tree list 203 will also be selected. A separate parts view is provided in 3D viewer window 207 to provide a more detail independent representation of the selected part. In addition, post delivery information is also provided in window 209 along with detailed parts information such as part number, unit price, supplier code, and inventory count for the selected part.

In addition to the returned search result in window 209, an option is provided for a user to play a virtual work instruction simulation for a selected document. As shown in window 209, the simulation is initiated by clicking on a play button 215. The virtual simulation is shown in window 217. During virtual simulation, a user is able to control the simulation player by means of toolbar 219 to manipulate the simulation playback for a step-by-step understanding of the work instructions.

User interface 200 also includes thumbnails 221 to be used as maintenance zones shortcuts for fast and easy access to the major maintenance zones on the aircraft. In this instance, there are four thumbnails 221 shown to correspond to four major maintenance zones. In other embodiments of the disclosure the number of thumbnails 221 may be different.

In instances where there is no access to the world wide web, a software package 119 that can be used in a disconnected environment can be provided to the disconnected computer 121. Computer 121 can, for example, be a tablet computer of a type commercially available. The software package 121 includes the 3D XML player, and at least the parts geometry warehouse database, the virtual work instructions database as well as the 3D navigation software. The software package may be provided in any of the available methods for providing software packages.

System 100 ties three dimensional viewing and navigating parts to all aircraft post delivery technical data of the affecting parts from a single point of access. Prior to system 100, an aircraft mechanic may read a maintenance document, read the task set out in the document, realize that the task references another task in another document and thus have to go open that task and so on until the entire process becomes uncovered. Advantageously, the embodiment of the present disclosure can search, retrieve, and aggregate these links from a previous authoring process and relieve the users from this tedious work process. The time saved transforms to an increase in work efficiency and productivity.

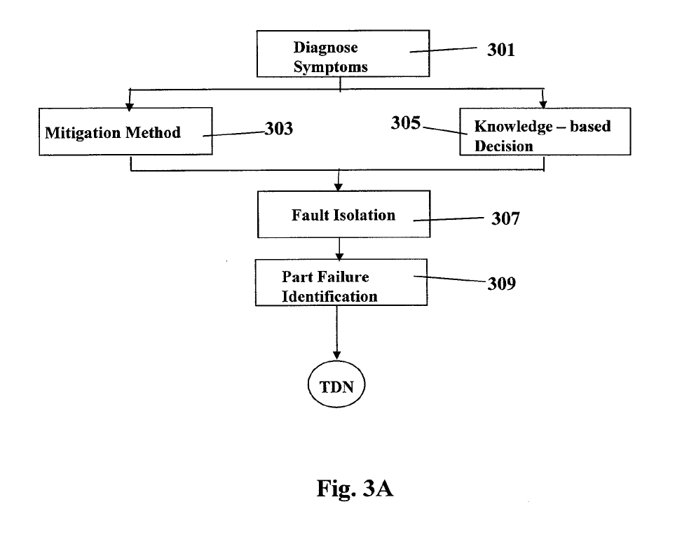

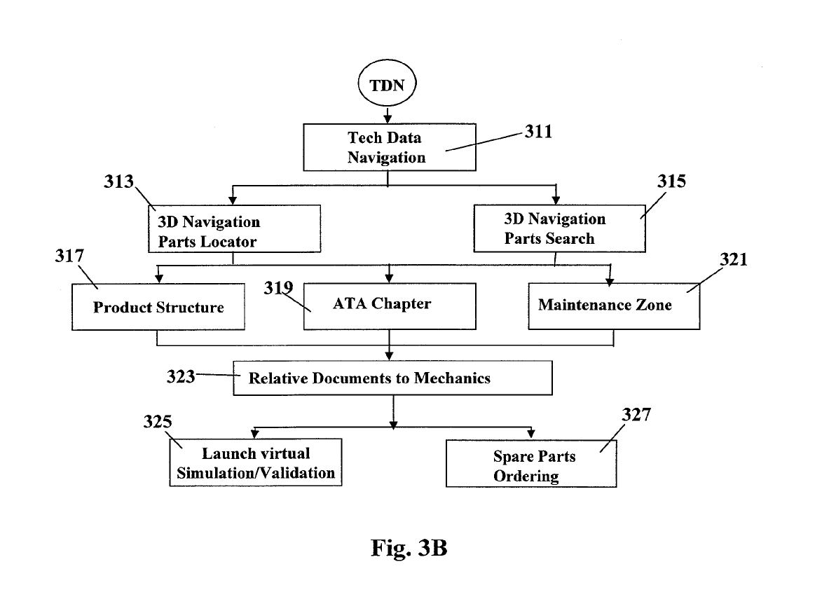

Turning now to FIGS. 3A and 3B, the methodology of the illustrative embodiment in relationship to maintenance operations is shown. FIG. 3A illustrates functional methodology for maintenance and repair diagnostic procedures and FIG. 3B illustrates the functional methodology of the technical data navigation system 100. An aircraft mechanic or user identifies symptoms of an aircraft at step 301. The user may utilize an aid to identify the symptoms which may, for example, be a computerized aid.

In the illustrative embodiment of the disclosure, the user may then use either one of two separate processes to determine how to fix the problem identified by the symptoms. The user may use either a mitigation method 303 or a knowledge based decision method 305. The mitigation method 303 is a step-by-step analytical approach. The knowledge based decision method 305 utilizes a database of how others have fixed the problem producing the symptoms. It will be appreciated by those skilled in the art that although the embodiment described herein utilizes two alternate specific methods to determine how to fix the problem represented by the symptoms that there are other methods available to determine how to fix the problem. The present invention is not limited to the specific methods for determining how to fix the problem, nor is the present invention limited by the number of processes or types of processes for determining how to fix the problem identified by the symptoms.

The result of the mitigation method 303 or decision method 305 is fault isolation 307 and/or identification of a part or parts to be replaced 309. However, the identification of the part or parts may not be specific to the part by part number or identifier.

At this point, the technical data navigation system and method 311 of the present disclosure is of particular value. The technical data navigation method 311 is shown in FIG. 3B. In reading the following description of the method of the disclosure reference is also made to the user interface 200 shown in FIG. 2.

The user utilizes the user interface 200 of FIG. 2 to select the navigation method of identifying a part of interest. By utilizing navigation menu 201, a user can view a parts specification list 313 as indicated in FIG. 3B or utilize 3D navigational viewer to do a 3D navigation part search 315. A parts specification list is provided in window 203 as shown in FIG. 2. From the parts specification list in window 203, a user can click on a part, indicated by way of example as part 205, and the 3D navigational viewer will automatically navigate to that part rendered in the 3D viewer in window 211. Subsequently, a search process is launched by repository server 107 of FIG. 1 to identify, as indicated in FIG. 3B, relevant technical data associated with the identified part by product structure 317, ATA chapters 319, or maintenance zone 321. The search inquiry would return all relevant post delivery documents 323 such as Service Bulletins, Maintenance Manuals, and Structural Repair Manuals relative to the selected part and display the results in window 209 of FIG. 2. Detailed parts information such as part number, unit price, supplier code, and inventory count are also displayed in window 209 for the selected part.

The user can navigate to a part on an aircraft via the 3D navigational viewer directly. The 3D viewer is provided in window 211. The 3D navigational viewer includes a tool bar 213 that can be utilized to help in the navigation. The user may change the view of the aircraft and drill down to the area of interest on the aircraft. When the user identifies the particular area of interest, the user can click on that area and an enlarged view of that particular area appears in window 207. Once the part of interest is found and selected in the 3D viewer of window 211, the location of the part in the parts specification tree list 203 will also be selected. A separate parts view is provided in 3D viewer window 207 to provide a more detail independent representation of the selected part. In addition, post delivery information is also provided in window 209 along with detailed parts information such as part number, unit price, supplier code, and inventory count for the selected part.

The user can launch, as shown in FIG. 3B, a virtual work instruction simulation 325 for a selected document. As shown in window 209 of FIG. 2, the simulation is initiated by clicking on a play button 215. The virtual simulation is shown in window 217. During virtual simulation, a user is able to control the simulation player by means of toolbar 219 to manipulate the simulation playback for a step-by-step understanding of the work instructions.

The user can also automatically order a replacement or spare for the part identified by executing a spare part ordering function 327 as indicated in FIG. 3B.

The system and method of the above-described embodiment provides a 3D navigational and parts rendering capability that streamlines the process of virtually locating and identifying parts on an aircraft. In addition, the technical data navigation system of the disclosure provides a capability to search and aggregate the necessary procedure documents that are needed to perform a requested task without the need to gather the documents manually.

One or more illustrative embodiments of the invention have been described. It will be appreciated by those skilled in the art that various changes and modifications can be made without departing from the scope of the invention. By way of example, communications in the embodiment of the invention is provided via the Internet or world wide web. In other embodiments, the communication system can be any communication system including by way of example, dedicated communication lines, fiber optic lines, satellite communication systems, telephone networks, and wireless data transmission systems, two-way cable systems, customized computer networks, hot spots, personal communication systems, and the like. It is not intended that the invention be limited by the embodiment shown and described but that the invention is limited only by the claims appended hereto.

What is claimed is:

1. A technical data navigation system for searching, retrieving and aggregating links related to vehicle maintenance and repair, comprising:
a technical data navigation system server;
a technical data navigation system client coupleable to said technical data navigation server;
a user interface provided by said technical data navigation system client to access and display data obtained from said technical data navigation system server in a plurality of windows, said user interface comprising a three dimensional viewer providing three dimensional navigation of a vehicle and its component subsystems and parts in one window;
a parts geometry database;
a virtual work instructions database;
a data repository server accessible by said technical data navigation server to respond to queries from said user interface and to provide data retrievals to said user interface from said parts geometry database and said virtual work instructions database;
a parts and structures assembly and generation program operable on said data repository server; and
a virtual work instructions authoring program to generate virtual work instructions stored in said virtual work instructions database.

2. A technical data navigation system in accordance with claim 1, wherein:
said user interface comprises a hierarchal specification tree of parts displayed in a second window by at least one of product structure, ATA chapters and damage location.

3. A technical data navigation system in accordance with claim 2, wherein:
said user interface comprises a window for searching for parts by at least one of part number and damage location.

4. A technical data navigation system in accordance with claim 1, wherein:
said user interface comprises navigating shortcut thumbnails to major maintenance zones.

5. A technical data navigation system in accordance with claim 1, wherein:
said parts and structures assembly and generation program and said virtual work instructions authoring program are utilized to translate data into part repair and replacement steps and to generate a three dimensional simulation of said part repair and replacement steps, said three dimensional simulation being stored in said virtual work instructions database and displayable on said user interface.

6. A technical data navigation system in accordance with claim 1, wherein:
said client accesses said technical data network server via a world-wide-web.

7. A technical data navigation system for searching, retrieving and aggregating links related to vehicle maintenance and repair, comprising:
a technical data navigation system server a technical data navigation system client coupleable to said technical data navigation server;
a user interface provided by said technical data navigation system client to access and display data obtained from said technical data navigation system server, said user interface comprising a three dimensional viewer providing three dimensional navigation of a vehicle and its component subsystems and parts;
said user interface comprising a display arranged into a plurality of windows, one of said windows providing a three dimensional view of said aircraft upon which a user may select a portion for closer view in a second one of said windows, said portion being presented in a three dimensional view upon which said user may select a part for viewing in a third window of said plurality of windows, said selected part being displayed in said third window as a three dimensional view;
said system server automatically providing to said user in one of said plurality of windows three dimensional virtual work instructions simulation.

8. A technical data navigation system in accordance with claim 7, comprising:
said user interface comprising a window providing identifying information for said selected part.

9. A technical data navigation system in accordance with claim 8, comprising:
said user interface including a portion of said display showing part ordering information for said selected part, and said user interface being operable to automatically order said selected part.

10. A technical data navigation system for searching, retrieving and aggregating links related to vehicle maintenance and repair, comprising:
a technical data navigation system server
a technical data navigation system client coupleable to said technical data navigation server;
a user interface provided by said technical data navigation system client to access and display data obtained from said technical data navigation system server, said user interface comprising:
a three dimensional viewer providing three dimensional navigation of a vehicle and its component subsystems and parts;
a hierarchal specification tree view of parts by at least one of product structure, ATA chapters and maintenance zone;
a list of parts by at least one of part numbers and damage location; and
navigating shortcut thumbnails to major maintenance zones of said vehicle;
a parts geometry database;
a virtual work instructions database; and
a data repository server accessible by said technical data navigation server to respond to queries from said user interface via said technical data navigation system server and to provide data retrievals to said user interface from said parts geometry database and said virtual work instructions database;
whereby said user interface provides a single point of access to search, retrieve and aggregate a vehicle manufacturer's post delivery technical data.

11. A technical data navigation system in accordance with claim 10, comprising:
a parts and structures assembly and generation program and a virtual work instructions authoring program utilized to translate data into part repair and replacement steps and to generate a corresponding three dimensional simulation of said part repair and replacement steps, said three dimensional simulation being stored in said virtual work instructions database.

12. A technical data navigation system in accordance with claim 10, wherein:
said client accesses said technical data network server via a world-wide-web.

13. A technical data navigation method for searching, retrieving and aggregating links related to vehicle maintenance and repair, comprising:
receiving user inputs for diagnosing symptoms of a vehicle;
utilizing said symptoms to isolate the occurrence of a corresponding fault;
providing a technical data navigation system comprising a user interface;
utilizing said user interface for accessing a technical data navigation system client to access and display data obtained from said technical data navigation system;
utilizing said user interface to provide a three dimensional viewer providing three dimensional navigation of said vehicle and its component subsystems and parts;
utilizing said user interface to provide a hierarchal specification tree view of parts;
utilizing said user interface to provide a list of parts by at least one of part numbers and damage location;
utilizing said user interface to provide navigating shortcut thumbnails to major maintenance zones of said vehicle;
providing a parts geometry database;
responding to selections via said user interface to search, retrieve, aggregate and display at said user interface documents relevant to a part of interest;
providing a virtual work instructions database of three dimensional simulations;
utilizing said user interface to launch and display three dimensional virtual simulations of work instructions from said virtual work instructions database.

14. A technical data navigation method in accordance with claim 13, comprising:
utilizing said user interface to order one or more parts identified on said user interface.

15. A technical data navigation method in accordance with claim 13, comprising:
accessing a mitigation method to isolate the occurrence of a said corresponding fault.

16. A technical data navigation method in accordance with claim 13, comprising:
accessing a knowledge based decision method to isolate the occurrence of a said corresponding fault.

17. A technical data navigation method in accordance with claim 13, comprising:
providing a plurality of windows to access and display data obtained from said technical data navigation system, said plurality of windows comprising:
a first window providing a three dimensional viewer for three dimensional navigation of said vehicle and its component subsystems and parts;
a second window providing said hierarchal specification tree view of parts; and
a third window providing list of parts by at least one of part numbers and damage location.

18. A technical data navigation method in accordance with claim 17, comprising:
providing one window of said plurality of windows to display said three dimensional virtual simulations of work instructions.

19. A technical data navigation method for searching, retrieving and aggregating links related to vehicle maintenance and repair, comprising:
providing a technical data navigation system server;
providing a technical data navigation system client coupleable to said technical data navigation server via the world-wide web;
providing a user interface at said client to access and display data obtained from said technical data navigation system server, said user interface comprising:
a viewer providing three dimensional navigation of a vehicle and its component subsystems and parts;
a hierarchal specification tree view of parts;
a list of parts by at least one of part numbers and damage location; and
navigating shortcut thumbnails to major maintenance zones of said vehicle;
providing a parts geometry database;
providing a virtual work instructions database;
providing a data repository server accessible by said technical data navigation server to respond to queries from said user interface via said technical data navigation system server and to provide data retrievals to said user interface from said parts geometry database and said virtual work instructions database; and
utilizing said user interface to provide single point of access to search, retrieve and aggregate a vehicle manufacturer's post delivery technical data.

20. A technical data navigation system method in accordance with claim 19, comprising:
providing part repair and replacement steps to said user interface from said parts geometry database;
selecting a three dimensional simulation of said part repair and replacement steps; and
displaying said three dimensional simulation on said user interface.
